(19) United States
(12) Patent Application Publication
(10) Pub. No.: US 2023/0280086 A1
(43) Pub. Date: Sep. 7, 2023

(54) REFRIGERATOR

(71) Applicant: Samsung Electronics Co., Ltd., Suwon-si (KR)

(72) Inventors: Chanbin PARK, Suwon-si (KR); Byoungmok KIM, Suwon-si (KR); Jaeung BANG, Suwon-si (KR); Sungjun CHO, Suwon-si (KR)

(21) Appl. No.: 18/316,985

(22) Filed: May 12, 2023

Related U.S. Application Data
(63) Continuation of application No. PCT/KR2021/013385, filed on Sep. 29, 2021.

(30) Foreign Application Priority Data
Nov. 18, 2020 (KR) 10-2020-0154278
Jul. 1, 2021 (KR) 10-2021-0086682

(51) Int. Cl. F25D 23/02

(52) U.S. Cl. CPC F25D 23/028

(57) ABSTRACT

A refrigerator comprises: a body having a storage compartment; a door body configured to open/close the storage compartment and including an upper cap and a lower cap; and a door panel detachably coupled to the front surface of the door body. The door panel comprises a panel body; an upper trim provided at the top of the rear surface of the panel body; and a lower trim provided at the bottom of the rear surface of the panel body. The refrigerator includes a fixer which locks the upper trim into a state where the upper trim is coupled to the upper cap, and the fixer is attached to the upper cap in such a manner that the fixer can move between a locked position in which the fixer locks the upper trim while attached to the upper cap and an unlocked position in which the fixer unlocks the upper trim while attached to the upper cap.

### CROSS-REFERENCE TO RELATED APPLICATIONS

This application is a Bypass Continuation of International Application No. PCT/KR2021/013385, filed Sep. 29, 2021, which claims priority to Korean Patent Application No. 10-2020-0154278, filed Nov. 18, 2020, and Korean Patent Application No. 10-2021-0086682, filed Jul. 1, 2021, the disclosures of which are herein incorporated by reference in their entirety.

### BACKGROUND

### 1. Field

The present disclosure relates to a refrigerator, and more particularly, to a refrigerator including a door having a detachable door panel.

### 2. Description of Related Art

In general, a refrigerator is an apparatus including a main body having storage compartments and a cold air supply system for supplying cold air to the storage compartments, thereby keeping food fresh. The storage compartments include a refrigerating compartment that is maintained at temperature of about 0 degrees Celsius to 5 degrees Celsius to keep food refrigerated, and a freezing compartment that is maintained at temperature of about 0 degrees Celsius to −30 degrees Celsius to keep food frozen. The front of the storage compartment is opened to allow food to be put in and out, and the opened front of the storage compartment is opened and closed by a door.

The door may include a door body having a heat insulating material and a door panel coupled to a front surface of the door body. Because the door panel is detachable from the front surface of the door body, a user may replace the door panel with another door panel having a different material, color, and design according to a taste of the user.

### SUMMARY

The present disclosure is directed to providing a refrigerator in which a material, color and design of a door may be easily changed.

The present disclosure is directed to providing a refrigerator in which a fixer for fixing a door panel is provided to be attached to a door body, thereby improving work easiness when the door panel is assembled with and separated from the door body.

An aspect of the present disclosure provides a refrigerator including a main body having a storage compartment, a door body configured to open and close the storage compartment and including an upper cap and a lower cap, a door panel detachably coupled to a front surface of the door body and including a panel body, an upper trim provided at an upper portion of a rear surface of the panel body to be coupled to the upper cap, and a lower trim provided at a lower portion of a rear surface of the panel body to be coupled to the lower cap, and a fixer attached to the upper cap and configured to be movable between a locked position in which an attachment of the upper trim is the upper cap is fixed and an unlocked position in which the locked attachment of the upper trim to the upper cap is unlocked.

The fixer may be attached to the upper cap to be rotatable about a fixer rotation shaft.

The fixer rotation shaft may extend along an X-axis direction, which is a left-right direction of the door body.

The fixer may include a first rotation coupling part, and the upper cap may include a second rotation coupling part rotatably coupled to the first rotation coupling part.

The upper trim may include a fixing groove. The fixer may include a fixing protrusion protruding to one side and configured to insert into the fixing groove in a manner to fix the upper trim to the upper cap.

The upper trim may include an upper trim groove. The upper cap may include an upper cap protrusion protruding forward and configured to insert into the trim groove in a manner to couple the upper cap to the upper trim.

The fixer may be attached to the upper cap to be movable along an X-axis direction, which is a left-right direction of the door body.

The fixer may include a pair of fixer rail parts extending along the X-axis direction, and the upper cap may include a pair of cap rail parts extending along the X-axis direction to be coupled to the pair of fixer rail parts.

The upper cap may include an upper cap body and an upper cap head detachably coupled to the upper cap body, and one of the pair of cap rail parts may be formed on the upper cap body and the other one of the pair of cap rail parts may be formed on the upper cap head.

The fixer may include a locking protrusion protruding downward to prevent separation of the upper trim when the fixer is in the locked position and allow the separation of the upper trim when the fixer is in the unlocked position.

The upper trim may include an upper trim body, an upper trim protrusion protruding rearward from the upper trim body, and an interference protrusion protruding from the upper trim protrusion to be caught on the locking protrusion when the fixer is in the locked position.

The fixer may be attached to the upper cap to be movable along a Y-axis direction, which is a vertical direction of the door body.

The upper trim may include a hook hole. The fixer may include a locking hook in which a front end thereof is bent upward and configured to insert into the hook hole in a manner to fix the upper trim.

The upper cap may include a mounting groove accommodating the fixer so that the fixer is movable along the Y-axis direction.

The refrigerator may further include an elastic member provided in the mounting groove to elastically bias the fixer to the locked position.

Another aspect of the present disclosure provides a refrigerator including a main body having a storage compartment, a door body provided to open and close the storage compartment and including an upper cap and a lower cap, a door panel including a panel body, a locking key protruding from an upper portion of a rear surface of the panel body, and a lower trim provided at a lower portion of the rear surface of the panel body to be coupled to the lower cap, the door panel being detachably coupled to a front surface of the door body, and a latch configured to fix the locking key when pressed in a first direction from the locking key in a state in which the locking key is not locked and to release the fixing of the locking key and push the locking key out when pressed in the first direction from the locking key in a state in which the locking key is fixed.

The latch may include a latch housing mounted on the upper cap and having an open front side, a slider provided inside the latch housing to be movable by being pressed by the locking key, an elastic member provided to elastically bias the slider toward a front side of the latch housing, a guide bar provided to limit a movement of the slider, and a latch hook provided to fix or release the locking key depending on a position of the slider.

The upper cap may include a latch accommodating space formed on a front surface of the upper cap to accommodate the latch housing.

The door body may include a front plate and a rear plate coupled to a rear surface of the front plate, the upper cap and the lower cap may be coupled to upper and lower ends of the front plate, respectively, and the front plate may include a front plate opening corresponding to the latch accommodating space to allow the locking key to pass therethrough.

The lower cap may include a lower cap protrusion protruding upward, the lower trim may include a lower trim groove into which the lower cap protrusion is inserted, the lower trim may be coupled to the lower cap as the lower cap protrusion is inserted into the lower trim groove, and when the lower trim is rotated about the lower cap protrusion in a direction in which the door panel is erected in a state of being coupled to the lower cap, the locking key may be fixed by the latch as the locking key presses the latch.

According to the present disclosure, because a fixer for fixing a door panel is attached to a door body, a work for fixing the door panel or releasing the fixing of the door panel can be easily performed.

According to the present disclosure, the door panel can be fixed to the door body by an operation of coming the door panel into close contact with the door body.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 is a view illustrating an exterior of a refrigerator according to an embodiment of the present disclosure.

FIG. 2 is an exploded view illustrating a door according to an embodiment of the present disclosure.

FIG. 3 is an exploded view illustrating a door body according to an embodiment of the present disclosure.

FIG. 4 is a perspective view illustrating a rear surface of a door panel according to an embodiment of the present disclosure.

FIG. 5 is a perspective view illustrating a fixer and an upper cap according to an embodiment of the present disclosure.

FIG. 6 is a view illustrating a process of coupling a lower trim of the door panel to a lower cap according to an embodiment of the present disclosure.

FIG. 7 is a view illustrating a state in which the lower trim of the door panel is coupled to the lower cap and the door panel is erected according to an embodiment of the present disclosure.

FIG. 8 is a cross-sectional view illustrating a state in which the fixer is in an unlocked position according to an embodiment of the present disclosure.

FIG. 9 is a cross-sectional view illustrating a state in which the fixer is in a locked position according to an embodiment of the present disclosure.

FIG. 10 is a view illustrating an upper trim according to another embodiment of the present disclosure.

FIG. 11 is a view illustrating a process of coupling the upper trim and an upper cap according to another embodiment of the present disclosure.

FIG. 12 is a cross-sectional view illustrating a state in which a fixer is in an unlocked position according to another embodiment of the present disclosure.

FIG. 13 is a cross-sectional view illustrating a state in which the fixer is in a locked position according to another embodiment of the present disclosure.

FIG. 14 is a view illustrating an upper trim according to another embodiment of the present disclosure.

FIG. 15 is a view illustrating an upper cap and a fixer according to another embodiment of the present disclosure.

FIG. 16 is a cross-sectional view illustrating the process of coupling the upper trim and the upper cap according to another embodiment of the present disclosure.

FIG. 17 is a cross-sectional view illustrating a state in which the fixer is in the locked position according to another embodiment of the present disclosure.

FIG. 18 is a cross-sectional view illustrating a state in which the fixer is in the unlocked position according to another embodiment of the present disclosure.

FIG. 19 is a view illustrating a door panel and a locking key according to another embodiment of the present disclosure.

FIG. 20 is a view illustrating an upper cap according to another embodiment of the present disclosure.

FIG. 21 is a side cross-sectional view illustrating a state in which a latch is in an unlocked position according to another embodiment of the present disclosure.

FIG. 22 is a plan cross-sectional view illustrating the latch in the state of FIG. 21.

FIG. 23 is a side cross-sectional view illustrating a state in which the latch is in a locked position according to another embodiment of the present disclosure.

FIG. 24 is a plan cross-sectional view illustrating the latch in the state of FIG. 23.

### DETAILED DESCRIPTION

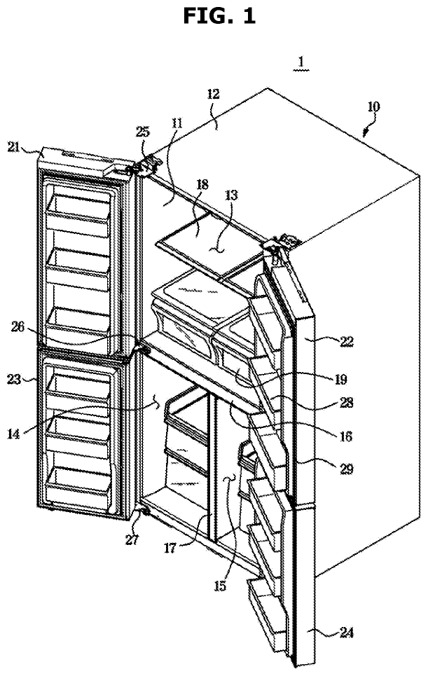

FIGS. 1 through 24, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

The embodiments described in the present specification and the configurations shown in the drawings are only examples of preferred embodiments of the present disclosure, and various modifications may be made at the time of filing of the present disclosure to replace the embodiments and drawings of the present specification.

The singular expressions herein may include plural expressions, unless the context clearly dictates otherwise. Also, the terms “comprises” and “has” are intended to indicate that there are features, numbers, steps, operations, elements, parts, or combinations thereof described in the specification, and do not exclude the presence or addition of one or more other features, numbers, steps, operations, elements, parts, or combinations thereof.

It will be understood that, although the terms first, second, etc. may be used herein to describe various components, these components should not be limited by these terms, and these terms are only used to distinguish one component from another.

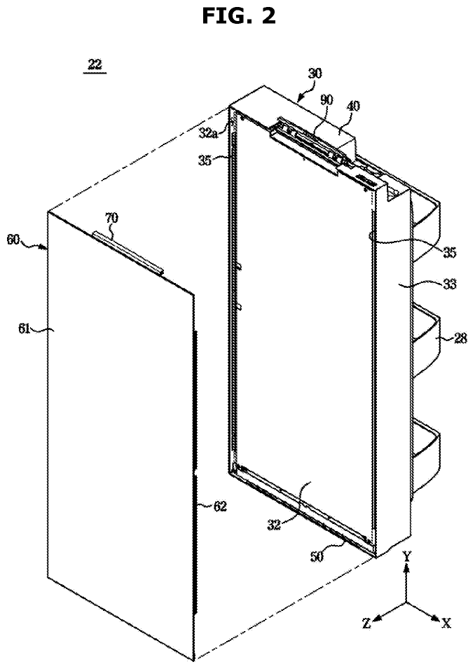

In this specification, directions to a right, left, upper, lower, front, and rear side may refer to +X direction, −X direction, +Y direction, −Y direction, +Z direction, and −Z direction, respectively, based on coordinate axes shown in FIG. 2.

Hereinafter, preferred embodiments according to the present disclosure will be described in detail with reference to the accompanying drawings.

FIG. 1 is a view illustrating an exterior of a refrigerator according to an embodiment of the present disclosure. Referring to FIG. 1, a refrigerator 1 may include a main body 10, storage compartments 13, 14, and 15 formed inside the main body 10, doors 21, 22, 23, and 24 provided to open and close the storage compartments 13, 14, and 15, and a cold air supply device (not shown) provided to supply cold air to the storage compartments 13, 14, and 15.

The main body 10 may include an inner case 11 forming storage compartments 13, 14, and 15, an outer case 12 coupled to the outside of the inner case 11 to form an exterior, and an insulator (not shown) provided between the inner case 11 and the outer case 12 to insulate the storage compartments 13, 14, and 15.

The storage compartments 13, 14, and 15 may be partitioned from each other by a horizontal partition wall 16 and a vertical partition wall 17. The storage compartments 13, 14, and 15 may be divided into the upper storage compartment 13 and the lower storage compartments 14 and 15 by the horizontal partition wall 16, and the lower storage compartments 14 and 15 may be divided into the lower left storage compartment 14 and the lower right storage compartment 15 by the vertical partition wall 17.

The upper storage compartment 13 may be used as a refrigerating compartment, and the lower storage compartments 14 and 15 may be used as a freezing compartment. However, the division and use of the storage compartments 13, 14, and 15 as described above is only an example, and is not limited thereto.

Shelves 18 for placing food and storage containers 19 for storing food may be provided inside the storage compartments 13, 14, and 15.

The cold air supply device may generate cold air using a refrigerant circulation cycle of compressing, condensing, expanding, and evaporating a refrigerant, and may supply the generated cold air to the storage compartments 13, 14, and 15.

The storage compartment 13 may be opened and closed by a pair of the doors 21 and 22. The doors 21 and 22 may be rotatably coupled to the main body 10. The storage compartment 14 may be opened and closed by the door 23, and the door 23 may be rotatably coupled to the main body 10. The storage compartment 15 may be opened and closed by the door 24, and the door 24 may be rotatably coupled to the main body 10. Hinges 25, 26, and 27 may be provided on the main body 10 to rotatably couple the doors 21, 22, 23, and 24 to the main body 10.

On rear surfaces of the doors 21, 22, 23, and 24, door pockets 28 provided to store food, and door gaskets 29 in close contact with a front surface of the main body 10 to seal the storage compartments 13, 14, and 15 may be provided.

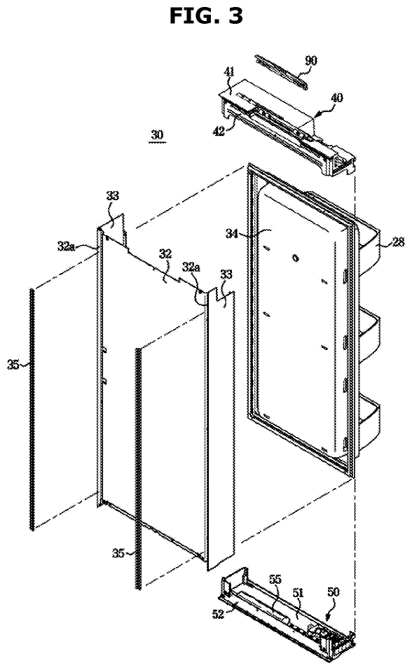

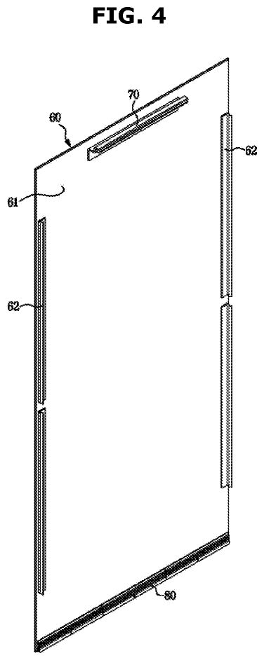

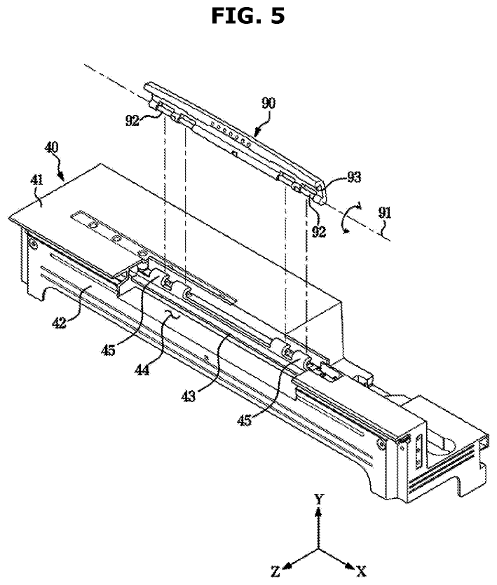

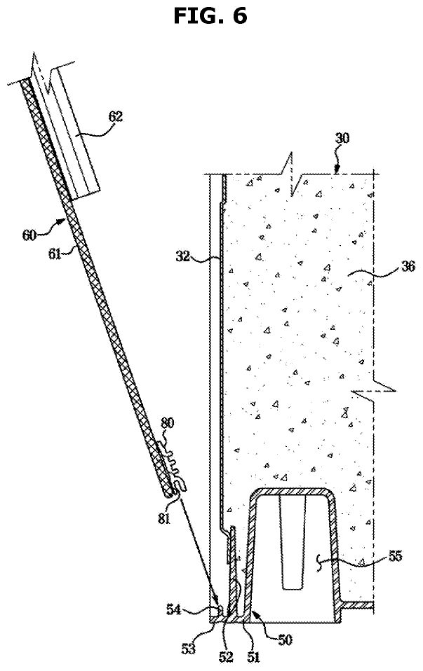

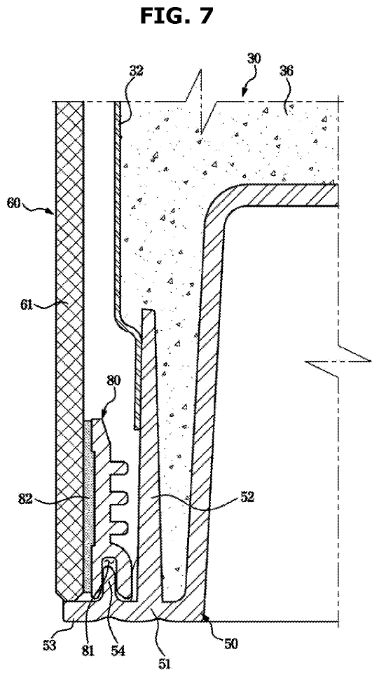

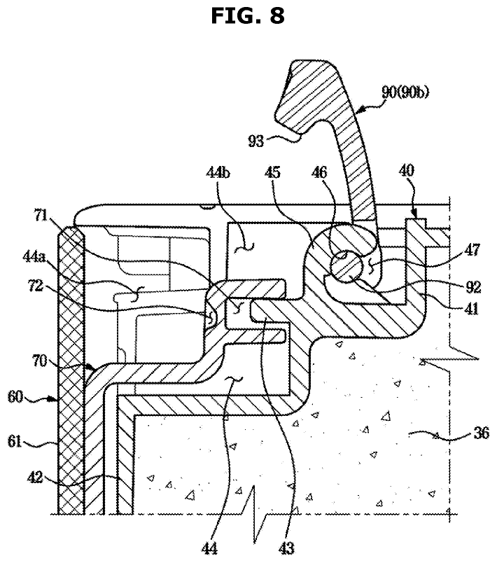

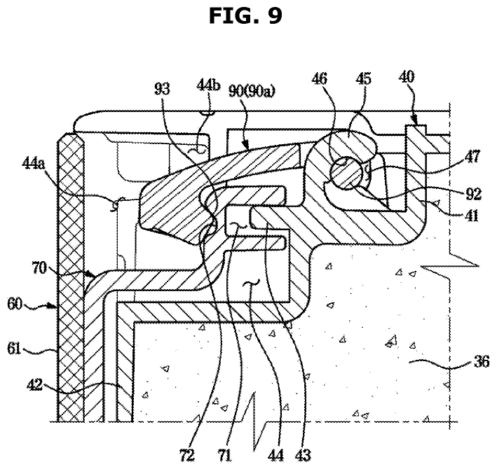

FIG. 2 is an exploded view illustrating a door according to an embodiment of the present disclosure. FIG. 3 is an exploded view illustrating a door body according to an embodiment of the present disclosure. FIG. 4 is a perspective view illustrating a rear surface of a door panel according to an embodiment of the present disclosure. FIG. 5 is a perspective view illustrating a fixer and an upper cap according to an embodiment of the present disclosure. FIG. 6 is a view illustrating a process of coupling a lower trim of the door panel to a lower cap according to an embodiment of the present disclosure. FIG. 7 is a view illustrating a state in which the lower trim of the door panel is coupled to the lower cap and the door panel is erected according to an embodiment of the present disclosure. FIG. 8 is a cross-sectional view illustrating a state in which the fixer is in an unlocked position according to an embodiment of the present disclosure. FIG. 9 is a cross-sectional view illustrating a state in which the fixer is in a locked position according to an embodiment of the present disclosure.

The configuration of the door 22 will be described below with reference to FIGS. 2 to 9. The configuration of the door 22 may be equally applicable to the other doors 21, 23, and 24.

The door 22 may include a door body 30 provided to open and close the storage compartment 13 and a door panel 60 detachably coupled to a front surface of the door body 30.

The door body 30 may be rotatably coupled to the main body 10 through the hinges 25 and 26. The door body 30 may include a front plate 32, both side plates 33, a rear plate 34, an upper cap 40, and a lower cap 50. The front plate 32, both the side plates 33, the rear plate 34, the upper cap 40, and the lower cap 50 may be assembled to form a foaming space therein, and an insulator 36 may be provided in the foaming space. A urethane foam insulator or a vacuum insulator may be used as the insulator 36.

The front plate 32 and both the side plates 33 may be formed of a metal material. The front plate 32 and both the side plates 33 may be integrally formed. However, unlike the present embodiment, the front plate 32 and both the side plates 33 may be separately formed and assembled. The upper cap 40 and the lower cap 50 may be injection molded of a resin material.

A front plate groove 32a in which a holder 35 is mounted may be formed on the front plate 32. The front plate groove 32a may be formed long in a vertical direction near each of both side edge portions of the front plate 32. A side trim 62 of the door panel 60 may be coupled to the holder 35. A door pocket 28 may be coupled to the rear plate 34.

The lower cap 50 may include a lower cap body 51, a support part 53 provided to support the door panel 60, and a lower cap protrusion 54 provided to be inserted into a lower trim groove 81 of a lower trim 80.

The lower cap body 51 may be coupled to lower ends of the front plate 32, both the side plates 33, and the rear plate 34. The lower cap body 51 may define the foaming space in which the insulator 36 is disposed. A front surface 52 of the lower cap body 51 may be coupled to the lower end of the front plate 32.

The support part 53 may be formed to protrude forward from a lower surface of the lower cap body 51 so as to support the door panel 60. The support part 53 may be provided to support a panel body 61 or the lower trim 80 provided at a lower end of the panel body 61. The support part 53 may protrude to be positioned in front of the front surface 52 of the lower cap body 51.

The lower cap 50 may include the lower cap protrusion 54 protruding upward. The lower cap protrusion 54 may be formed to protrude upward from one point of the support part 53. The lower cap protrusion 54 may be inserted into the lower trim groove 81 of the lower trim 80. The lower trim 80 may be coupled to the lower cap 50 as the lower cap protrusion 54 is inserted into the lower trim groove 81. The lower cap protrusion 54 may support the lower trim 80.

In a state in which the lower trim 80 is coupled to the lower cap 50, the door panel 60 may rotate about the lower cap protrusion 54. Specifically, in the state in which the lower trim 80 is coupled to the lower cap 50, the door panel 60 may rotate between an inclined position and an erected position about the lower cap protrusion 54.

The lower cap 50 may include a handle 55 provided to open and close the door 22 by holding the handle 55 with a hand. The handle 55 may be formed to be recessed on a lower surface of the lower cap 50.

The upper cap 40 may include an upper cap body 41, an upper cap protrusion 43 provided to couple an upper trim 70, and a rotation coupling part 45 provided to couple a fixer 90.

The upper cap body 41 may be coupled to upper ends of the front plate 32, both the side plates 33, and the rear plate 34. The upper cap body 41 may define the foaming space in which the insulator 36 is disposed. A front surface 42 of the upper cap body 41 may be coupled to the upper end of the front plate 32.

The upper cap protrusion 43 may protrude forward from the upper cap body 41. The upper cap protrusion 43 may be inserted into an upper trim groove 71 of the upper trim 70. The upper trim 70 may be coupled to the upper cap 40 as the upper cap protrusion 43 is inserted into the upper trim groove 71.

When the upper trim 70 is coupled to the upper cap 40, the upper trim 70 may be accommodated in an accommodation space 44 of the upper cap 40.

A front surface 44a and an upper surface 44b of the accommodation space 44 may be formed to be open. The upper trim 70 may be inserted into the accommodation space 44 through the open front surface 44a of the accommodation space 44. The fixer 90 may be inserted into the accommodation space 44 through the open upper surface 44b of the accommodation space 44 to fix the upper trim 70 disposed in the accommodation space 44.

A rotation coupling part 92 of the fixer 90 may be rotatably coupled to the rotation coupling part 45 of the upper cap 40. The rotation coupling part 92 of the fixer 90 may be formed in a rod shape to form a fixer rotation axis 91, and the rotation coupling part 45 of the upper cap 40 may be formed in a cylindrical shape surrounding the rotation coupling part 92 of the fixer 90 so as to rotatably support the rotation coupling part 92 of the fixer 90.

The rotation coupling part 45 of the upper cap 40 may include a shaft hole 46 provided to accommodate the rotation coupling part 92 of the fixer 90. A shaft insertion hole 47 may be formed on one side of the rotation coupling part 45 of the upper cap 40 so that the rotation coupling part 92 of the fixer 90 is inserted into the shaft hole 46.

However, unlike the present embodiment, the rotation coupling part 45 of the upper cap 40 may be formed in a rod shape to form a fixer rotation axis, and the rotation coupling part 92 of the fixer 90 may be formed in a cylindrical shape surrounding the rotation coupling part 45 of the upper cap 40.

The door panel 60 may include the panel body 61, and the trims 62, 70 and 80 attached to a rear surface of the panel body 61 for coupling of the door panel 60 and the door body 30.

The panel body 61 may be formed to correspond to a size of the door body 30. Therefore, the front surface of the door body 30 may be covered by the panel body 61 and may not be exposed. The panel body 61 may be formed to have various materials, colors and designs. The panel body 61 may be formed of a material such as glass, metal, or plastic. Although not shown in the drawings, when the panel body 61 is made of a metal material, an edge end of the panel body 61 may be formed to be bent rearward. A buffer member (not shown) may be provided on the rear surface of the panel body 61 to alleviate friction and shock when coupled with the door body 30.

The door panel 60 may be provided on the front surface of the door body 30 to enable easy coupling and separation. Therefore, a material, color and design of a front surface of the door 22 may be easily changed by replacing the door panel 60.

The trims 62, 70, and 80 may include the upper trim 70 attached to an upper edge portion of the rear surface of the panel body 61, the side trims 62 attached to both left and right edge portions of the rear surface of the panel body 61, and the lower trim 80 attached to a lower edge portion of the rear surface of the panel body 61. The upper trim 70 and the lower trim 80 may be formed long in a horizontal direction, and the side trims 62 may be formed long in the vertical direction.

The upper trim 70, the side trims 62, and the lower trim 80 may be attached to the rear surface of the panel body 61 through an adhesive 82. However, unlike the present embodiment, the upper trim 70, the side trims 62, and the lower trim 80 may be integrally formed with the panel body 61.

The lower trim 80 may include the lower trim groove 81. The lower trim groove 81 may be open downward. The lower cap protrusion 54 of the lower cap 50 may be inserted into the lower trim groove 81.

The side trim 62 may be fitted and coupled to the holder 35 mounted on the door body 30. However, unlike the present embodiment, a magnet may be used instead of the side trim 62. The magnet may be tightly coupled to the front plate of the door made of a metal material by a magnetic force.

The upper trim 70 may include the upper trim groove 71 and a fixing groove 72. The upper cap protrusion 43 of the upper cap 40 may be inserted into the upper trim groove 71. The upper trim groove 71 may be open rearward so that the upper cap protrusion 43 is inserted into the upper trim groove 71.

A fixing protrusion 93 of the fixer 90 may be inserted into the fixing groove 72. The upper trim 70 may be fixed as the fixing protrusion 93 of the fixer 90 is inserted into the fixing groove 72. The fixing groove 72 may be formed to be open forward. That is, the fixing groove 72 and the upper trim groove 71 may be formed to be open in opposite directions.

The door 22 may include the fixer 90 provided to fix or release the upper trim 70 in a state in which the upper trim 70 is coupled to the upper cap 40. The fixer 90 may be attached to the upper cap 40. Because the fixer 90 is attached to the upper cap 40, the fixer 90 may move integrally together with the upper cap 40 regardless of whether the fixer 90 is in a locked position 90a or in an unlocked position 90b.

The fixer 90 may be movable to the locked position 90a (FIG. 9) in which an attachment of the upper trim 70 to the upper cap 40 is fixed, and to the unlocked position 90b (FIG. 8) in which fixing of the attachment of the upper trim 70 the upper cap 40 is released.

The fixer 90 may be rotatably attached to the upper cap 40 about the fixer rotation shaft 91. The fixer rotation shaft 91 may extend along an X-axis direction, which is a left-right direction of the door body 30.

The fixer 90 includes the rotation coupling part 92, and the rotation coupling part 92 of the fixer 90 may be rotatably coupled to the rotation coupling part 45 of the upper cap 40. The fixer 90 may be attached to the upper cap 40 as the rotation coupling part 92 of the fixer 90 is coupled to the rotation coupling part 45 of the upper cap 40.

The fixer 90 may include the fixing protrusion 93 inserted into the fixing groove 72 of the upper trim 70 and protruding to fix the upper trim 70. The fixing protrusion 93 is formed in a curved surface and may be inserted into the fixing groove 72 while sliding when the fixer 90 rotates from the unlocked position 90b to the locked position 90a.

As such, because the fixer 90 is attached to the upper cap 40, work easiness may be improved when the door panel 60 is coupled to or separated from the door body 30.

A process of coupling the door panel 60 to the door body 30 will be described below with reference to FIGS. 6 to 9.

First, as illustrated in FIG. 6, the lower trim 80 and the lower cap 50 are coupled. Specifically, the lower cap protrusion 54 may be inserted into the lower trim groove 81 by tilting the door panel 60.

Next, as illustrated in FIGS. 7 and 8, the upper trim 70 and the upper cap 40 may be coupled. When the door panel 60 is rotated about the lower cap protrusion 54 in a direction of erecting the door panel 60, the upper trim 70 and the upper cap 40 may be coupled as the upper cap protrusion 43 is inserted into the upper trim groove 71. At this time, the fixer 90 is positioned at the unlocked position 90b, so that the upper trim 70 may not interfere with the fixer 90 in a process in which the upper trim 70 and the upper cap 40 are coupled.

Next, as illustrated in FIG. 9, the upper trim 70 may be fixed or locked by rotating the fixer 90 from the unlocked position 90b to the locked position 90a about the fixer rotation axis 91.

A process of separating the door panel 60 from the door body 30 may be performed opposite to the process of coupling the door panel 60.

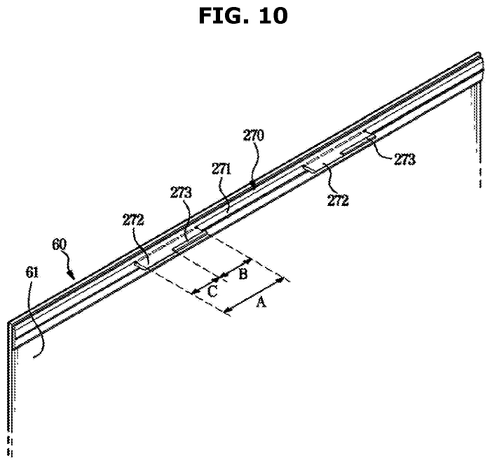

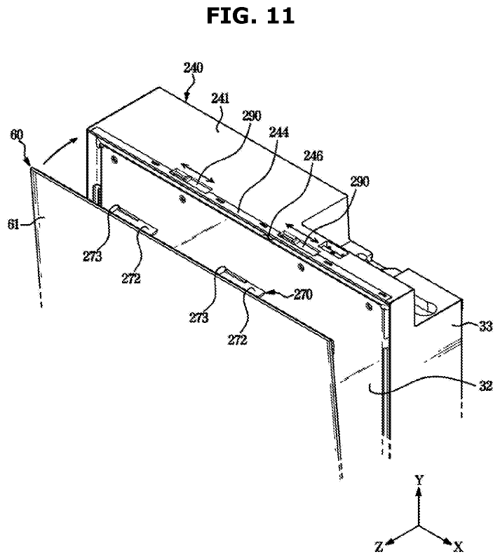

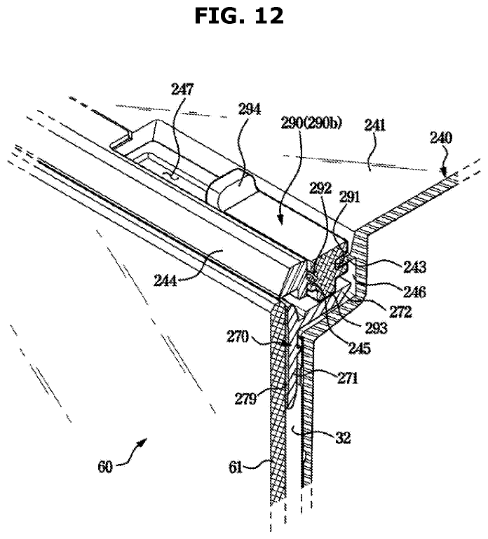

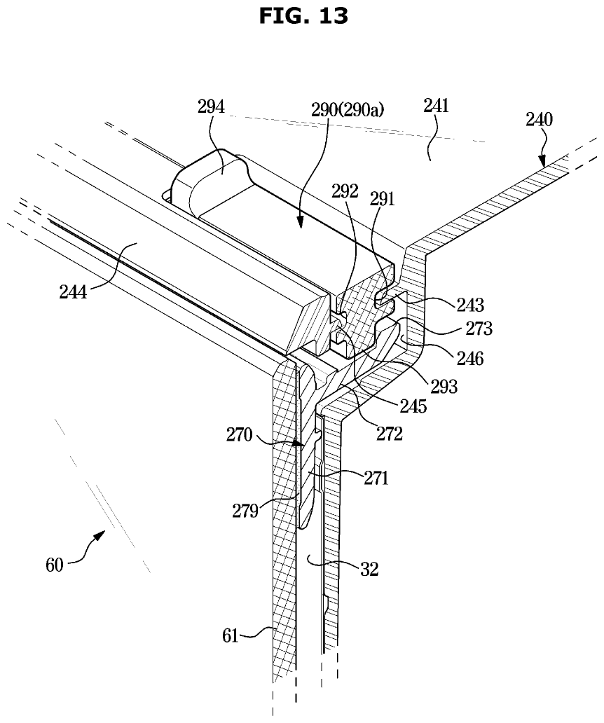

FIG. 10 is a view illustrating an upper trim according to another embodiment of the present disclosure. FIG. 11 is a view illustrating a process of coupling the upper trim and an upper cap according to another embodiment of the present disclosure. FIG. 12 is a cross-sectional view illustrating a state in which a fixer is in an unlocked position according to another embodiment of the present disclosure. FIG. 13 is a cross-sectional view illustrating a state in which the fixer is in a locked position according to another embodiment of the present disclosure.

An upper cap, an upper trim, and a fixer according to another embodiment of the present disclosure will be described below with reference to FIGS. 10 to 13. The same reference numerals are assigned to components identical to those of the above-described embodiment, and descriptions thereof may be omitted.

An upper cap 240, an upper trim 270, and a fixer 290 according to another embodiment of the present disclosure to be described below may be applied to the refrigerator of the above-described embodiment.

The upper trim 270 may be attached to the upper edge portion of the rear surface of the panel body 61 through an adhesive 279. The upper trim 270 may include an upper trim body 271 extending along the left-right direction of the panel body 61, an upper trim protrusion 272 protruding rearward from the upper trim body 271, and an interference protrusion 273 protruding from the upper trim protrusion 272.

The interference protrusion 273 may protrude upward from the upper trim protrusion 272. The interference protrusion 273 may be provided to be caught on a locking protrusion 293 of the fixer 290 when the fixer 290 is in a locked position 290a. Therefore, the interference protrusion 273 of the upper trim 270 interferes with the locking protrusion 293 of the fixer 290 when the fixer 290 is in the locked position 290a, so that the upper trim 270 may be prevented from separating from the upper cap 240.

In addition, the interference protrusion 273 may not be caught on the locking protrusion 293 of the fixer 290 when the fixer 290 is in an unlocked position 290b. When the fixer 290 is in the unlocked position 290b, the interference protrusion 273 of the upper trim 270 may not interfere with the locking protrusion 293 of the fixer 290, and the upper trim 270 may be detachable from the upper cap 240.

To this end, the interference protrusion 273 may be formed only in a partial section B of an entire section A along a left-right direction of the upper trim protrusion 272 and may not be formed in a remaining section C. The partial section B may correspond to the locked position 290a of the fixer 290, and the remaining section C may correspond to the unlocked position 290b of the fixer 290.

The upper cap 240 may include an upper cap body 241 and an upper cap head 244 coupled to the upper cap body 241. The upper cap head 244 may be coupled to an upper end of a front surface of the upper cap body 241.

The upper cap body 241 may be coupled to the upper ends of the front plate 32, both the side plates 33, and the rear plate 34. The upper cap body 241 may define a foaming space in which the insulator 36 is disposed.

The upper cap 240 may include an upper cap groove 246 provided for coupling the upper trim 270 and the upper cap 240, and cap rail parts 243 and 245 provided for coupling of the fixer 290 and the upper cap 240.

The upper cap groove 246 may be open forward, and the upper trim protrusion 272 of the upper trim 270 may be inserted into the upper cap groove 246. The upper trim 270 may be coupled to the upper cap 240 as the upper trim protrusion 272 is inserted into the upper cap groove 246.

Fixer rail parts 291 and 292 of the fixer 290 may be movably coupled to the cap rail parts 243 and 245 of the upper cap 240. The first cap rail part 243 and the second cap rail part 245 may be formed to face each other with a gap 247 therebetween, and may be formed to protrude toward the gap 247. That is, the first cap rail part 243 and the second cap rail part 245 may be formed in a protrusion shape protruding toward the gap 247. The fixer rail parts 291 and 292 of the fixer 290 may be formed in groove shapes into which the cap rail parts 243 and 245 are inserted.

However, unlike the present embodiment, the cap rail parts 243 and 245 may be formed in a groove shape, and the fixer rail parts 291 and 292 may be formed in a protrusion shape.

Among a pair of the cap rail parts 243 and 245, the first cap rail part 243 may be formed on the upper cap body 241, and the second cap rail part 245 may be formed on the upper cap head 244.

As such, because among the pair of cap rail parts 243 and 245, the first cap rail part 243 is formed on the upper cap body 241, and the second cap rail part 245 is formed on the upper cap head 244 coupled to the upper cap body 241, the fixer 290 may be easily installed in the gap 247 formed between the first cap rail part 243 and the second cap rail part 245.

That is, in the state in which the upper cap body 241 is coupled to the upper ends of the front plate 32, both the side plates 33, and the rear plate 34, the first fixer rail part 291 of the fixer 290 may be coupled to the first cap rail part 243 of the upper cap body 241. In a state in which the first fixer rail part 291 of the fixer 290 is coupled to the first cap rail part 243 of the upper cap body 241, the upper cap head 244 may be coupled to the upper cap body 241 so that the second cap rail part 245 of the upper cap head 244 is coupled to the second fixer rail part 292 of the fixer 290. The upper cap head 244 and the upper cap body 241 may be coupled using various coupling methods, and there is not limited in the method.

The door 22 may include the fixer 290 provided to fix or release the upper trim 270 in a state in which the upper trim 270 is coupled to the upper cap 240. The fixer 290 may be attached to the upper cap 240. Because the fixer 290 is attached to the upper cap 240, the fixer 290 may move integrally together with the upper cap 240 regardless of whether the fixer 290 is in the locked position 290a or in the unlocked position 290b.

The fixer 290 may be movable to the locked position 290a (FIG. 13) for fixing an attachment of the upper trim 270 to the upper cap 240, and to the unlocked position 290b (FIG. 12) for releasing the fixed attachment of the upper trim 270 to the upper cap 240.

The fixer 290 may move along the X-axis direction, which is the left-right direction of the door body 30. For example, the fixer 290 may be positioned at the locked position (FIG. 13) by moving leftward from the unlocked position (FIG. 12), and may be positioned at the unlocked position (FIG. 12) by moving rightward from the locked position (FIG. 13).

The fixer 290 may include a pair of the fixer rail parts 291 and 292.

The fixer 290 may include the locking protrusion 293 protruding downward to prevent separation of the upper trim 270 when the fixer 290 is in the locked position 290a and allow the separation of the upper trim 270 when the fixer 290 is in the unlocked position 290b. The fixer 290 may include a manipulation protrusion 294 protruding upward to manipulate the fixer 290 by hand.

As such, because the fixer 290 is attached to the upper cap 240, the work easiness may be improved when the door panel 60 is coupled to or separated from the door body 30.

The process of coupling the door panel 60 to the door body 30 will be described below with reference to FIGS. 6 to 7 and FIGS. 11 to 13.

First, as illustrated in FIG. 6, the lower trim 80 and the lower cap 50 are coupled. Specifically, the lower cap protrusion 54 may be inserted into the lower trim groove 81 by tilting the door panel 60.

Next, as illustrated in FIG. 7 and FIGS. 11 to 12, the upper trim 270 and the upper cap 240 may be coupled. When the door panel 60 is rotated about the lower cap protrusion 54 in the direction of erecting the door panel 60, the upper trim 270 and the upper cap 240 may be coupled as the upper trim protrusion 272 is inserted into the upper cap groove 246. At this time, the fixer 290 is positioned at the unlocked position 290b, so that the upper trim 270 may not interfere with the fixer 290 in a process in which the upper trim 270 and the upper cap 240 are coupled.

Next, as illustrated in FIG. 13, the upper trim 270 may be fixed or locked by sliding the fixer 290 from the unlocked position 290b to the locked position 290a.

The process of separating the door panel 60 from the door body 30 may be performed in the reverse order of the above coupling process.

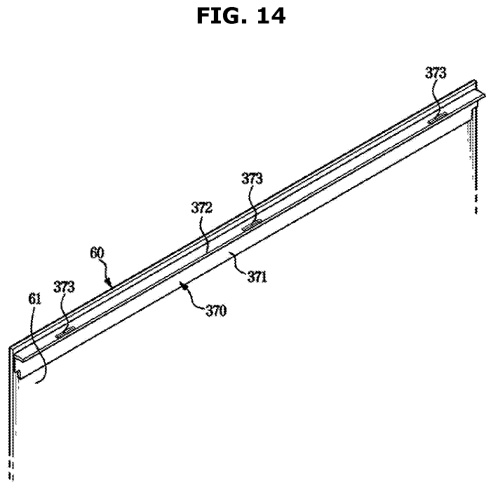

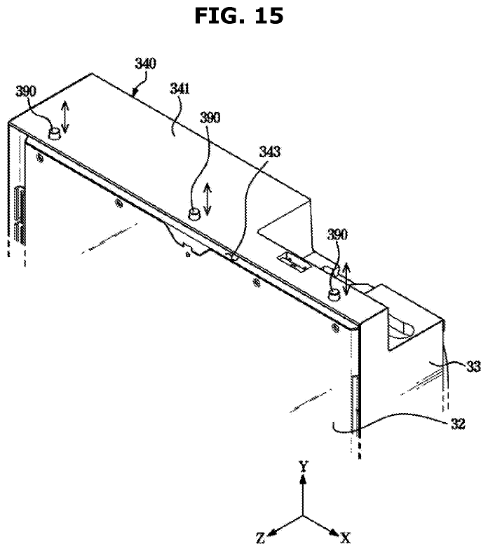

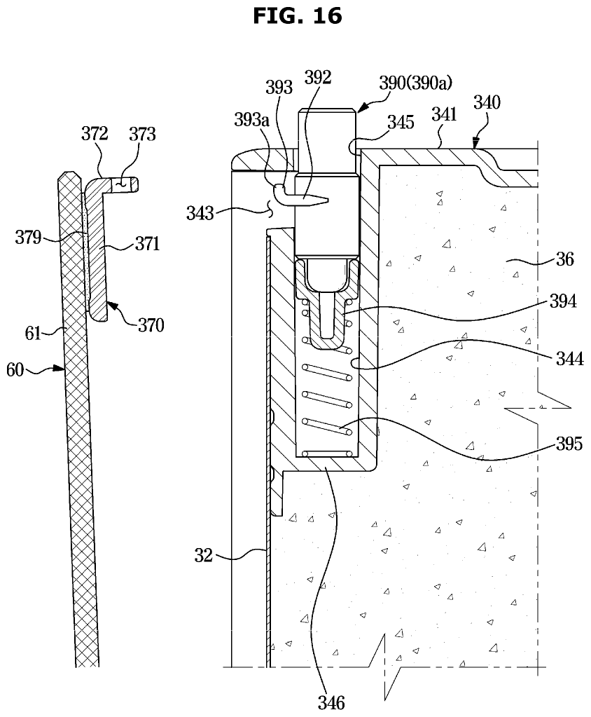

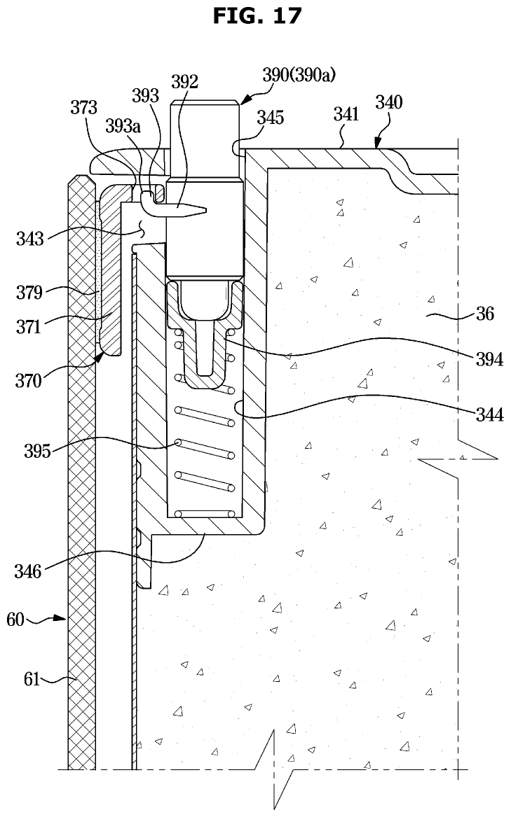

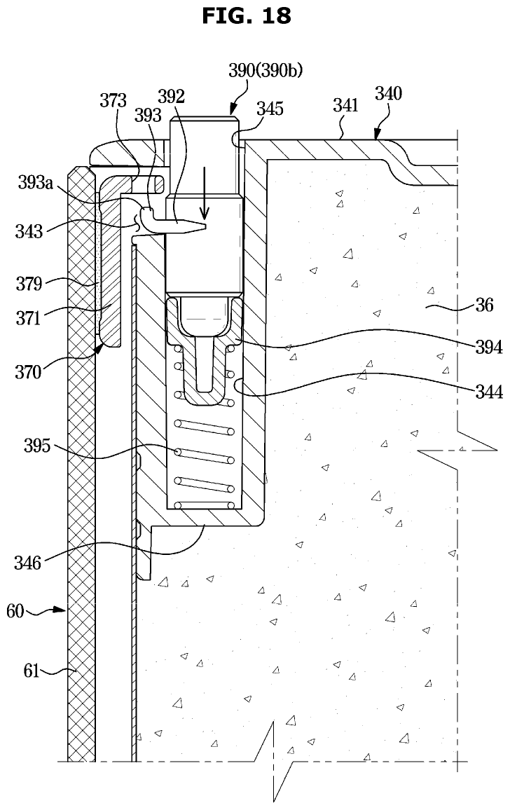

FIG. 14 is a view illustrating an upper trim according to another embodiment of the present disclosure. FIG. 15 is a view illustrating an upper cap and a fixer according to another embodiment of the present disclosure. FIG. 16 is a cross-sectional view illustrating the process of coupling the upper trim and the upper cap according to another embodiment of the present disclosure. FIG. 17 is a cross-sectional view illustrating a state in which the fixer is in the locked position according to another embodiment of the present disclosure. FIG. 18 is a cross-sectional view illustrating a state in which the fixer is in the unlocked position according to another embodiment of the present disclosure.

An upper cap, an upper trim, and a fixer according to another embodiment of the present disclosure will be described below with reference to FIGS. 14 to 18. The same reference numerals are assigned to components identical to those of the above-described embodiments, and descriptions thereof may be omitted.

An upper cap 340, an upper trim 370, and a fixer 390 according to another embodiment of the present disclosure to be described below may be applied to the refrigerators of the above-described embodiments.

The upper trim 370 may be attached to the upper edge portion of the rear surface of the panel body 61 through an adhesive 379. The upper trim 370 may include an upper trim body 371 extending along the left-right direction of the panel body 61, an upper trim protrusion 372 protruding rearward from the upper trim body 371, and a hook hole 373 formed in the upper trim protrusion 372. The number of hook holes 373 corresponding to the number of fixers 390 may be provided.

The upper cap 340 may include an upper cap body 341 and a mounting groove 344 formed on the upper cap body 341 to which the fixer 390 is mounted.

The upper cap body 341 may be coupled to the upper ends of the front plate 32, both the side plates 33, and the rear plate 34. The upper cap body 341 may define a foaming space in which the insulator 36 is disposed.

A portion of the fixer 390 may be accommodated in the mounting groove 344. The fixer 390 may be movable in a Y-axis direction, which is the vertical direction, while accommodated in the mounting groove 344. An upper cap upper surface opening 345 is formed on an upper side of the mounting groove 344, and the fixer 390 may protrude to the outside of the upper cap 340 through the upper cap upper surface opening 345. An upper cap front surface opening 343 is formed in front of the mounting groove 344, and the upper trim protrusion 372 of the upper trim 370 may be inserted into the upper cap front surface opening 343. The upper trim 370 may be coupled to the upper cap 340 as the upper trim protrusion 372 is inserted into the upper cap front surface opening 343.

The upper cap front surface opening 343 may be connected to the mounting groove 344. A locking hook 392 of the fixer 390 may be disposed in the upper cap front surface opening 343. The upper trim protrusion 372 and the locking hook 392 may be coupled at the upper cap front surface opening 343.

An elastic member 395 may be provided in the mounting groove 344 to elastically bias the fixer 390 to a locked position 390a. One end of the elastic member 395 may be connected to a mounting groove lower surface 346, and the other end of the elastic member 395 may be connected to a support member 394 supporting the fixer 390.

The door 22 may include the fixer 390 provided to fix or release the upper trim 370 in a state in which the upper trim 370 is coupled to the upper cap 340. The fixer 390 may be attached to the upper cap 340. Because the fixer 390 is attached to the upper cap 340, the fixer 390 may move integrally together with the upper cap 340 regardless of whether the fixer 390 is in the locked position 390a or in the unlocked position 390b.

The fixer 390 may be movable to the locked position 390a (FIGS. 16 and 17) in which the upper trim 370 may be fixedly attached to the upper cap 340, and to the unlocked position 390b (FIG. 18) in which the locked attachment of the upper trim 370 to the upper cap 340 may be released or unlocked.

The fixer 390 may move along the Y-axis direction, which is the vertical direction of the door body 30. For example, the fixer 390 may be moved downward from the locked position 390a to be positioned at the unlocked position (FIG. 18). In addition, the fixer 390 may be moved upward from the unlocked position 390b to be positioned at the locked position (FIGS. 16 and 17).

Because the fixer 390 is provided to be elastically biased to the locked position 390a by the elastic member 395, the fixer 390 may move from the unlocked position 390b to the locked position 390a by an elastic force of the elastic member 395.

The fixer 390 may include the locking hook 392 provided to be caught on the hook hole 373 of the upper trim 370. The locking hook 392 may include a front end 393 bent upward, and the front end 393 may be inserted into the hook hole 373. The fixer 390 may fix the upper trim 370 as the front end 393 of the locking hook 392 is inserted into the hook hole 373.

As such, because the fixer 390 is attached to the upper cap 340, the work easiness may be improved when the door panel 60 is coupled to or separated from the door body 30.

The process of coupling the door panel 60 to the door body 30 will be described below with reference to FIGS. 6 and 7 and FIGS. 16 to 18.

First, as illustrated in FIG. 6, the lower trim 80 and the lower cap 50 are coupled. Specifically, the lower cap protrusion 54 may be inserted into the lower trim groove 81 by tilting the door panel 60.

Next, as illustrated in FIGS. 7, 16, and 17, the upper trim 370 and the upper cap 340 may be coupled. When the door panel 60 is rotated about the lower cap protrusion 54 in the direction of erecting the door panel 60, the upper trim 370 and the upper cap 340 may be coupled as the upper trim protrusion 372 is inserted into the upper cap front surface opening 343.

While inserting the upper trim protrusion 372 into the upper cap front surface opening 343, the upper trim protrusion 372 comes into contact with a curved front upper end 393a of the locking hook 392 of the fixer 390 to push the fixer 390 downward.

When the insertion of the upper trim protrusion 372 into the upper cap front surface opening 343 is completed, the fixer 390 may move upward again by the elastic force of the elastic member 395. Accordingly, the front end 393 of the locking hook 392 of the fixer 390 is inserted into the hook hole 373 of the upper trim 370 so that the upper trim 370 may be fixed.

As illustrated in FIG. 18, when the door panel 60 is to be separated from the door body 30, the fixer 390 may be pressed down to move the fixer 390 from the locked position 390a to the unlocked position 390b. In a state in which the fixer 390 is in the unlocked position 390b, the door panel 60 is rotated to tilt about the lower cap protrusion 54 so that the upper trim 370 and the upper cap 340 may be separated. In a state in which the upper trim 370 and the upper cap 340 are separated, the lower trim 80 and the lower cap 50 may be separated.

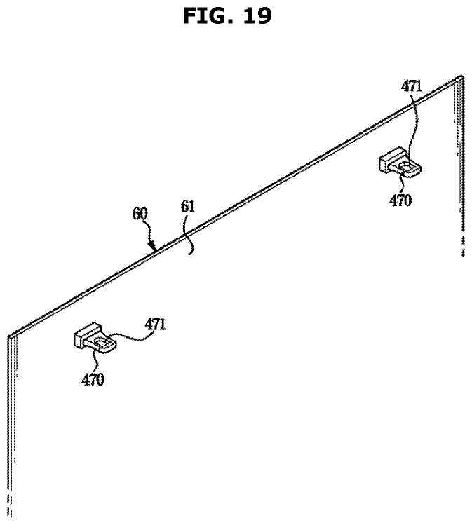

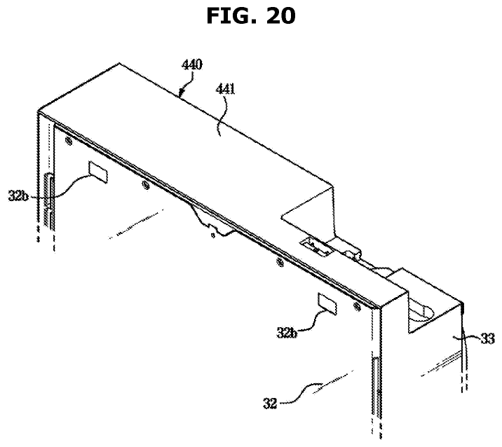

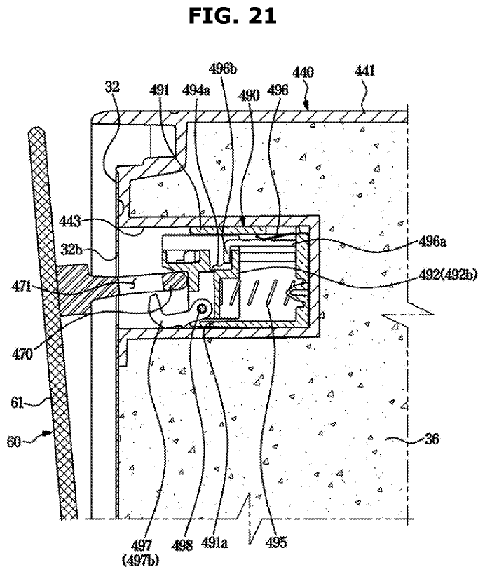

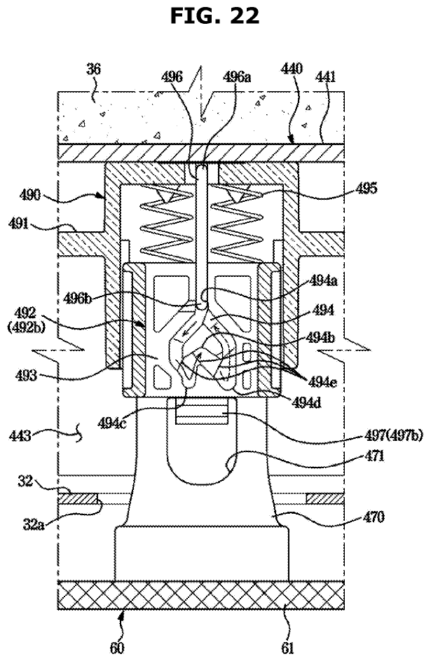

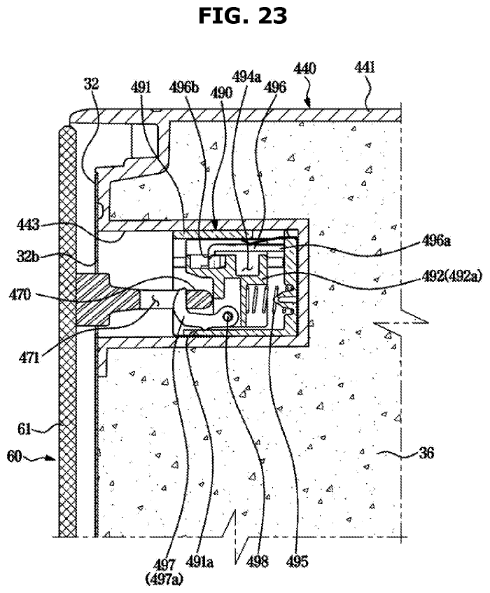

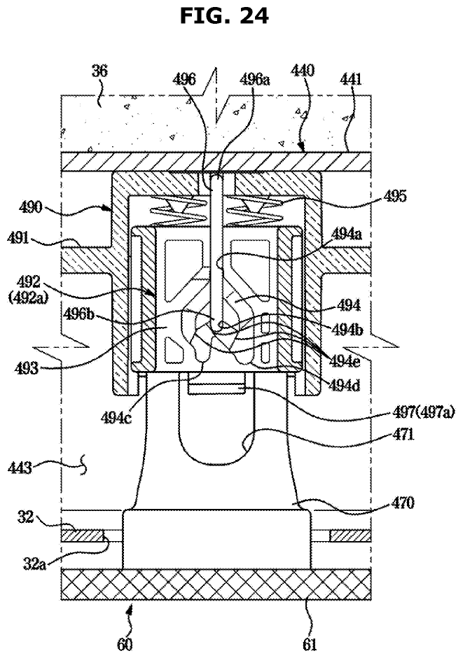

FIG. 19 is a view illustrating a door panel and a locking key according to another embodiment of the present disclosure. FIG. 20 is a view illustrating an upper cap according to another embodiment of the present disclosure. FIG. 21 is a side cross-sectional view illustrating a state in which a latch is in an unlocked position according to another embodiment of the present disclosure. FIG. 22 is a plan cross-sectional view illustrating the latch in the state of FIG. 21. FIG. 23 is a side cross-sectional view illustrating a state in which the latch is in a locked position according to another embodiment of the present disclosure. FIG. 24 is a plan cross-sectional view illustrating the latch in the state of FIG. 23.

An upper cap, a locking key, and a latch according to another embodiment of the present disclosure will be described below with reference to FIGS. 19 to 23. The same reference numerals are assigned to components identical to those of the above-described embodiment, and descriptions thereof may be omitted.

An upper cap 440, a locking key 470, and a latch 490 according to another embodiment of the present disclosure to be described below may be applied to the refrigerators of the above-described embodiments. In particular, the locking key 470 may be applied instead of the upper trims of the above-described embodiments, and the latch 490 may be applied instead of the fixers.

The locking key 470 may be attached to an upper portion of the rear surface of the panel body 61 through an adhesive or the like. A key hole 471 may be formed on the locking key 470. A latch hook 497 of the latch 490 may be inserted into the key hole 471. The locking key 470 may be fixed as the latch hook 497 is inserted into the key hole 471.

The upper cap 440 may include an upper cap body 441 and a latch accommodating space 443 formed in the upper cap body 441 to mount the latch 490 thereon. The latch accommodating space 443 may be formed such that a front surface thereof is open.

The upper cap body 441 may be coupled to upper ends of the front plate 32, both the side plates 33, and the rear plate 34. The upper cap body 441 may define a foaming space in which the insulator 36 is disposed. A front plate opening 32b may be formed on the front plate 32 to allow the locking key 470 to pass therethrough.

The latch 490 may be configured to fix the locking key 470 when pressed backward from the locking key 470 in a state in which the locking key 470 is not fixed. The latch 490 may be configured to push the locking key 470 forward while releasing the fixing of the locking key 470 when pressed backward from the locking key 470 in a state in which the locking key 470 is fixed.

Specifically, the latch 490 may include a latch housing 491 mounted in the latch accommodating space 443 of the upper cap body 441 and having an open front side, a slider 492 provided inside the latch housing 491 to be movable by being pressed by the locking key 470, an elastic member 495 provided to elastically support the slider 492, a guide bar 496 provided to guide a movement of the slider 492, and the latch hook 497 provided to fix or release the locking key 470 depending on a position of the slider 492.

The slider 492 may be movable between a locked position 492a (FIGS. 23 and 24) and an unlocked position 492b (FIGS. 21 and 22). The latch hook 497 may move between the locked position 497a (FIGS. 23 and 24) and the unlocked position 497b (FIGS. 21 and 22) depending on the movement of the slider 492.

The latch hook 497 may be coupled to the slider 492 to be rotatable about a latch hook rotation shaft 498. The latch hook 497 may be rotated by a rotation guide part 491a of the latch housing 491 depending on the position of the slider 492.

The elastic member 495 may be provided to elastically bias the slider 492 to the unlocked position 492b.

A guide groove 494 into which a movable end 496b of the guide bar 496 is inserted may be formed on an upper surface 493 of the slider 492. The guide groove 494 is formed in a closed loop, and may include an unlocking groove 494a, a locking groove 494b, a first stop groove 494c, a second stop groove 494d, and a stepped portion 494e.

The guide bar 496 may include a fixed end 496a fixed to the latch housing 491 and the movable end 496b provided to move along the guide groove 494.

When the slider 492 is pressed rearward by the locking key 470 while in the unlocked position 492b, the movable end 496b of the guide bar 496 may move in the direction of an arrow (solid line) (FIG. 22). In a process of moving the movable end 496b in the direction of the arrow (solid line), the stepped portion 494e of the guide groove 494 may prevent the movable end 496b from moving backward.

That is, the movable end 496b may be stopped by passing through the first stop groove 494c from the unlocking groove 494a and from catching on the locking groove 494b, and accordingly, the slider 492 may stop at the locked position 492a.

When the slider 492 is in the unlocked position 492b, the latch hook 497 may be positioned at the unlocked position 497b separated from the key hole 471 of the locking key 470, and while the slider 492 moves from the unlocked position 492b to the locked position 492a, the latch hook 497 may be rotated and inserted into the key hole 471. Accordingly, when the slider 492 is positioned at the locked position 492a, the latch hook 497 may be positioned at the locked position 497a to fix the locking key 470.

When the slider 492 is pressed rearward by the locking key 470 while in the locked position 492a, the movable end 496b of the guide bar 496 may move in the direction of an arrow (solid line) (FIG. 22). In a process of moving the movable end 496b in the direction of the arrow (solid line), the stepped portion 494e of the guide groove 494 may prevent the movable end 496b from moving backward.

That is, the movable end 496b may be stopped by passing through the second stop groove 494d from the locking groove 494b and from catching on the unlocking groove 494a, and accordingly, the slider 492 may stop at the unlocked position 492b.

While the slider 492 moves from the locked position 492a to the unlocked position 492b, the latch hook 497 may be rotated and separated from the key hole 471. Accordingly, when the slider 492 is positioned at the unlocked position 492b, the latch hook 497 may be positioned at the unlocked position 497b to release the fixing of the locking key 470.

Therefore, when the slider 492 is pressed rearward by the locking key 470 while in the locked position 492a, the slider 492 may push the locking key 470 forward while moving somewhat rearward and then moving forward again.

Processes of coupling and separating the door panel 60 to and from the door body 30 will be described below with reference to FIGS. 6 to 7 and FIGS. 21 to 24.

First, as illustrated in FIG. 6, the lower trim 80 and the lower cap 50 may be coupled. Specifically, the lower cap protrusion 54 may be inserted into the lower trim groove 81 by tilting the door panel 60.

Next, as illustrated in FIGS. 7, 21 and 22, when the door panel 60 is rotated about the lower cap protrusion 54 in the direction of erecting the door panel 60 in the state in which the lower trim 80 is coupled to the lower cap 50, the locking key 470 may press the latch 490 rearward so that the locking key 470 may be fixed by the latch 490.

As illustrated in FIGS. 23 and 24, when the door panel 60 is pushed rearward in a state in which the locking key 470 is fixed to the latch 490, the locking key 470 may press the latch 490 rearward to release the fixing of the locking key 470 so that the locking key 470 may be separated from the latch 490.

In a state in which the locking key 470 and the latch 490 are separated, the door panel 60 may be separated from the door body 30 by separating the lower trim 80 and the lower cap 50.

The door structures of the above-described embodiments may be applied not only to the refrigerators but also to various home appliances such as a clothes care device, a shoe care device, a cooking appliance, a dishwasher, and an air conditioner.

That is, the home appliance may include a home appliance body having an inner space with an open side in order to perform a predetermined function, and a home appliance door coupled to the home appliance body to open and close the open side of the inner space, and the door structures of the above-described embodiments may be applied to the home appliance door.

Although the technical spirit of the present disclosure has been described by specific embodiments, the scope of the present disclosure is not limited to these embodiments. Various embodiments that may be modified or modified by those skilled in the art of the present disclosure would also be within the scope of the present disclosure, without departing from the gist of the present disclosure specified in the claims.

Although the present disclosure has been described with various embodiments, various changes and modifications may be suggested to one skilled in the art. It is intended that the present disclosure encompass such changes and modifications as fall within the scope of the appended claims.

What is claimed is:

1. A refrigerator comprising:
a main body having a storage compartment;
a door body configured to open and close the storage compartment and comprising an upper cap and a lower cap;
a door panel detachably coupled to a front surface of the door body and comprising:
a panel body,
an upper trim provided at an upper portion of a rear surface of the panel body to be coupled to the upper cap, and
a lower trim provided at a lower portion of the rear surface of the panel body to be coupled to the lower cap; and
a fixer attached to the upper cap and configured to be movable between a locked position in which an attachment of the upper trim to the upper cap is locked and an unlocked position in which the locked attachment of the upper trim to the upper cap is unlocked.

2. The refrigerator according to claim 1, wherein the fixer is attached to the upper cap to be rotatable about a fixer rotation shaft.

3. The refrigerator according to claim 2, wherein the fixer rotation shaft extends along an X-axis direction, which is a left-right direction of the door body.

4. The refrigerator according to claim 2, wherein:
the fixer comprises a first rotation coupling part, and
the upper cap comprises a second rotation coupling part rotatably coupled to the first rotation coupling part.

5. The refrigerator according to claim 1, wherein:
the upper trim comprises a fixing groove, and
the fixer comprises a fixing protrusion protruding to one side and configured to insert into the fixing groove in a manner to fix the upper trim to the upper cap.

6. The refrigerator according to claim 1, wherein:
the upper trim comprising an upper trim groove, and
the upper cap comprises an upper cap protrusion protruding forward and configured to insert into the upper trim groove in a manner to couple the upper cap to the upper trim.

7. The refrigerator according to claim 1, wherein the fixer is attached to the upper cap to be movable along an X-axis direction, which is a left-right direction of the door body.

8. The refrigerator according to claim 7, wherein:
the fixer comprises a pair of fixer rail parts extending along the X-axis direction, and
the upper cap comprises a pair of cap rail parts extending along the X-axis direction to be coupled to the pair of fixer rail parts.

9. The refrigerator according to claim 8, wherein:
the upper cap comprises an upper cap body and an upper cap head detachably coupled to the upper cap body, and
one of the pair of cap rail parts is formed on the upper cap body and the other one of the pair of cap rail parts is formed on the upper cap head.

10. The refrigerator according to claim 7, wherein the fixer comprises a locking protrusion protruding downward and configured to prevent separation of the upper trim when the fixer is in the locked position and allow the separation of the upper trim when the fixer is in the unlocked position.

11. The refrigerator according to claim 10, wherein the upper trim comprises:
an upper trim body;
an upper trim protrusion protruding rearward from the upper trim body; and
an interference protrusion protruding from the upper trim protrusion to be caught on the locking protrusion when the fixer is in the locked position.

12. The refrigerator according to claim 1, wherein the fixer is attached to the upper cap to be movable along a Y-axis direction, which is a vertical direction of the door body.

13. The refrigerator according to claim 12, wherein:
the upper trim comprises a hook hole, and
the fixer comprises a locking hook in which a front end thereof is bent upward and configured to insert into the hook hole in a manner to fix the upper trim.

14. The refrigerator according to claim 12, wherein the upper cap comprises a mounting groove accommodating the fixer so that the fixer is movable along the Y-axis direction.

15. The refrigerator according to claim 14, further comprising:
an elastic member provided in the mounting groove to elastically bias the fixer to the locked position.

16. A refrigerator including:
a main body having a storage compartment,
a door body provided to open and close the storage compartment and including an upper cap and a lower cap,
a door panel detachably coupled to a front surface of the door body and including:
a panel body,
a locking key protruding from an upper portion of a rear surface of the panel body, and
a lower trim provided at a lower portion of the rear surface of the panel body to be coupled to the lower cap, and
a latch configured to fix the locking key when pressed in a first direction from the locking key in a state in which the locking key is not fixed and to release the fixing of the locking key and push the locking key out when pressed in the first direction from the locking key in a state in which the locking key is fixed.

17. The refrigerator according to claim 16, wherein the latch includes:
a latch housing mounted on the upper cap and having an open front side,
a slider provided inside the latch housing to be movable by being pressed by the locking key,
an elastic member provided to elastically bias the slider toward a front side of the latch housing,
a guide bar provided to limit a movement of the slider, and
a latch hook provided to fix or release the locking key depending on a position of the slider.

18. The refrigerator according to claim 16, wherein the upper cap includes a latch accommodating space formed on a front surface of the upper cap to accommodate the latch housing

19. The refrigerator according to claim 16, wherein:
the door body includes a front plate and a rear plate coupled to a rear surface of the front plate,
the upper cap and the lower cap is be coupled to upper and lower ends of the front plate, respectively, and
the front plate includes a front plate opening corresponding to the latch accommodating space to allow the locking key to pass therethrough.

20. The refrigerator according to claim 16, wherein:
the lower trim includes a lower trim groove,
the lower cap includes a lower cap protrusion protruding upward and configured to insert into the lower trim groove in a manner that the lower cap is coupled to the lower trim, and
when the lower trim is rotated about the lower cap protrusion in a direction in which the door panel is erected while coupled to the lower cap, the locking key is fixed by the latch as the locking key presses the latch.
